(19) United States
(12) Patent Application Publication
(10) Pub. No.: US 2008/0165247 A1
(43) Pub. Date: Jul. 10, 2008

(54) IMAGE PROCESSING APPARATUS AND METHOD

(75) Inventors: Ratna Beresford, Basingstoke (GB); Daniel James Lennon, Basingstoke (GB)

Correspondence Address: OBLON, SPIVAK, MCCLELLAND MAIER & NEUSTADT, P.C., 1940 DUKE STREET, ALEXANDRIA, VA, 22314, US

(73) Assignee: SONY UNITED KINGDOM LIMITED, Weybridge (GB)

(21) Appl. No.: 11/943,981

(22) Filed: Nov. 21, 2007

(30) Foreign Application Priority Data
Jan. 9, 2007 (GB) 0700352.8

(51) Int. Cl. H04N 7/18

(52) U.S. Cl. 348/65; 348/E09.047

(57) ABSTRACT

An image processing apparatus is operable to generate at least one processed image from an input image. The image processing apparatus is operable to receive the input image represented as a plurality of pixels each of which includes red, green and blue component values and to apply, for example, a k-means clustering algorithm to identify k local mean for the values of the red, green and blue component values, where k is an integer. The image processing apparatus is operable to identify for each local mean of the pixels for each of the red, green and blue components, a candidate range of component values, and a mapping function for mapping the candidate range of component values onto a dynamic range of possible component values for representing the image. The image processing apparatus is operable to apply for each of the red, green and blue components of each pixel of the input image the identified mapping function, to form for each of the k-local mean a processed image for display.

Embodiments of the present invention can provide a system which can be used, in one application to assist surgeons during visible light endoscopic examinations. The system can be used by surgeons to detect and analyse lesions in operating theatres, thereby reducing a need for histologies and repeat procedures.

### BACKGROUND OF THE INVENTION

1. Field of the Invention

The present invention relates to image processing methods and apparatus for generating processed versions of input images by mapping pixel values of images on to pixel values of the processed versions of the images. In one example, the images may be produced from parts of the body captured, for example, from an endoscope during surgery on the human or animal body and displayed for review by a surgeon.

2. Description of the Prior Art

It is known to process images in some way so as to make features of interest which appear in those images clearer or to some extent more easily recognisable. In one example, the images can be medical images, such as X-rays or images produced by endoscopes. Endoscopes provide one example of generating medical images inside the body for diagnosing and treating a human or animal patient. However, generally when faced with an image from inside the body, the surgeon may not immediately recognise areas of interest which may require surgery and/or treatment of some kind.

WO 96/13805 discloses an image processing apparatus in which enhancements are made by spatial histogram analysis of images generated for example, from X-rays. The enhancement is made by compressing the tonal range and in some cases expanding the contrast range of an area of interest to reveal more significant information depending upon the purpose of the image. In some examples, the image is segmented in order to perform a histogram analysis. In one example, the segmentation is performed by applying a k-means clustering algorithm.

A technical problem is concerned with providing an improvement in processing images so that features of those images can be viewed more clearly.

### SUMMARY OF THE INVENTION

According to the present invention there is provided an image processing apparatus operable to generate at least one processed image from an input image. The image processing apparatus is operable to receive the input image represented as a plurality of pixels each of which includes red, green and blue component values and to identify k local mean for each of the red, green and blue component values of the pixels, where k is an integer. The image processing apparatus is operable to identify for each of the k local mean, for each of the red, green and blue components, a candidate range of component values, and a mapping function for mapping the candidate range of the component values of the onto an available dynamic range of possible component values for representing the image. The image processing apparatus is operable to apply for each of the red, green and blue components of each pixel of the input image the mapping function identified for each of the k local mean, to form for each of the k-local mean a processed image for display.

In one example, the k local mean of the component values of the pixels of the image are identified using a k means clustering algorithm.

Embodiments of the present invention can provide a system which can be used, in one application to assist surgeons during visible light endoscopic examinations. The system can be used by surgeons to detect and analyse lesions in operating theatres, thereby reducing a need for histologies and repeat procedures. The system applies a contrast adjustment method to images in order to highlight areas or features of interest, such as lesions and the detailed structure on their surface, within endoscopic images. The system processes the image produced to use, as much of the dynamic range of the display device as possible, to display the area of the image containing the lesion. The distribution of pixel values in the input image is analysed and candidate ranges selected which include the feature or area of interest which may contain, for example, lesions. These candidate ranges can then be used to generate candidate images which contain an enhanced view of the lesion. In some examples, the candidate image is selected for displaying the lesion with the highest amount of detail. This can be acceptable in an operating theatre. Once the candidate image has been selected the system can display the result in real-time alongside the original endoscopic video image.

The system can be applied in real-time to video data from standard definition or high definition visible light endoscopes. The system can also provide still image and video capture functions to enable peer review and future DICOM compliance. The system can be used to enhance the diagnostic capabilities of existing endoscopic equipment.

Various further aspects and features of the present invention are defined in the appended claims.

### BRIEF DESCRIPTION OF THE DRAWINGS

The above and another objects, features and advantages of the invention will be apparent from the following detailed description of illustrative embodiments which is to be read in connection with the accompanying drawings, in which:

### BRIEF DESCRIPTION OF THE DRAWINGS

Embodiments of the present invention will now be described with reference to the accompanying drawings where like parts have corresponding alphanumeric references, and in which;

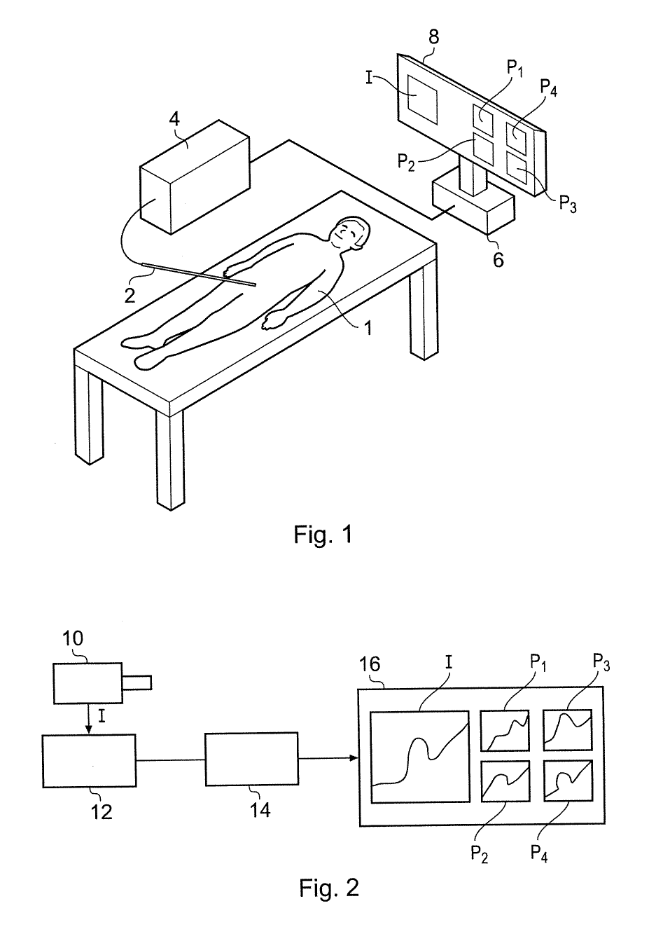

FIG. 1 is a schematic illustration of a system in which a medical image is generated and processed in accordance with the present technique;

FIG. 2 is a schematic diagram of parts which are used to produce the image in accordance with the present technique;

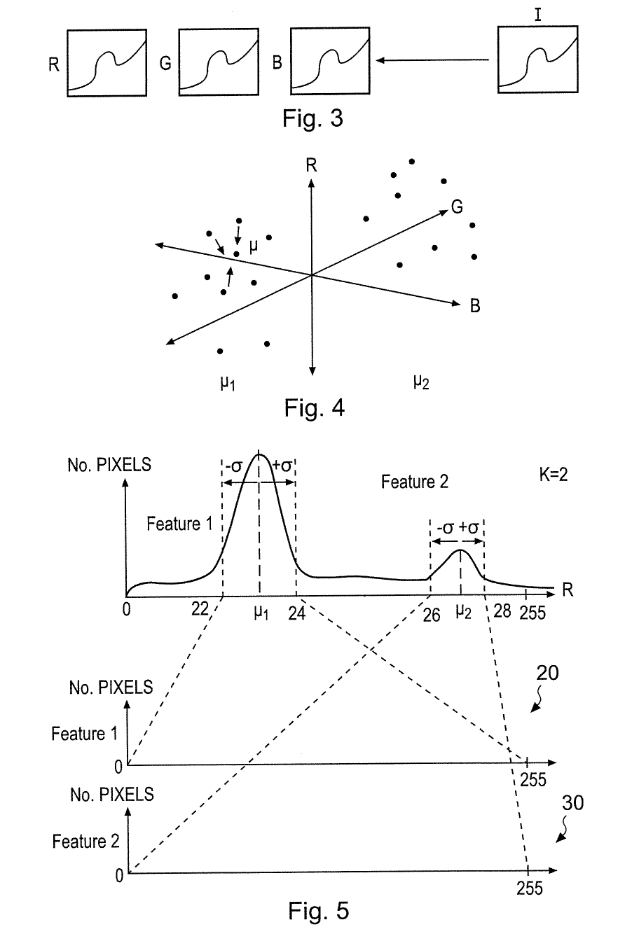

FIG. 3 is an example illustration of an image showing red, green and blue components;

FIG. 4 is a schematic illustration showing the plotting of the pixel values of the image into an RGB signal space;

FIG. 5 is an illustrative representation of mapping a local dynamic range of a feature of interest onto a total dynamic range available for two local means identified using K=2 for a K means clustering algorithm for the red component of an image;

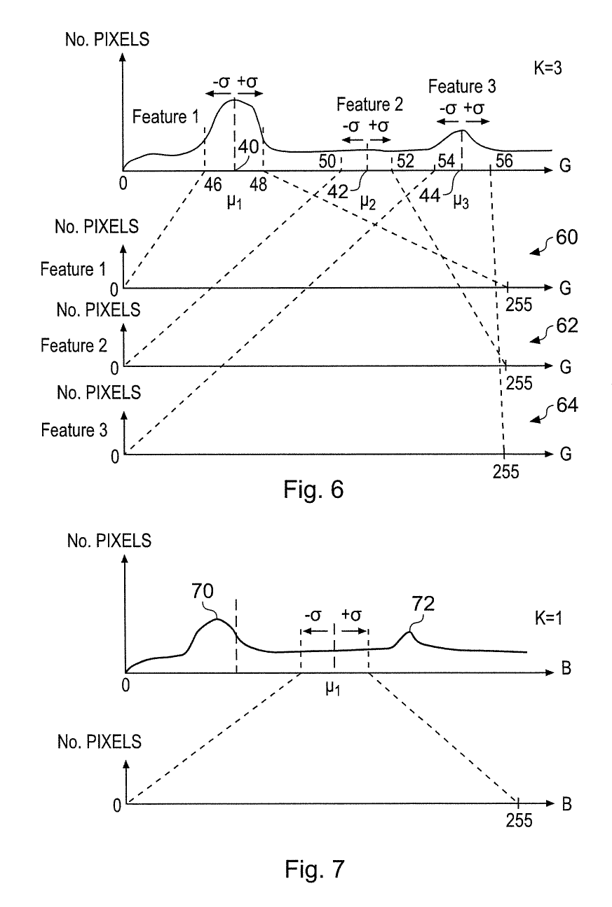

FIG. 6 is a schematic illustration showing a mapping of local dynamic ranges of three features onto a total dynamic range for K=3 for the K means clustering algorithm for the green component of the image;

FIG. 7 is a schematic illustration corresponding to those shown in FIGS. 5 and 6 for the blue component for K=1 of the K means clustering algorithm;

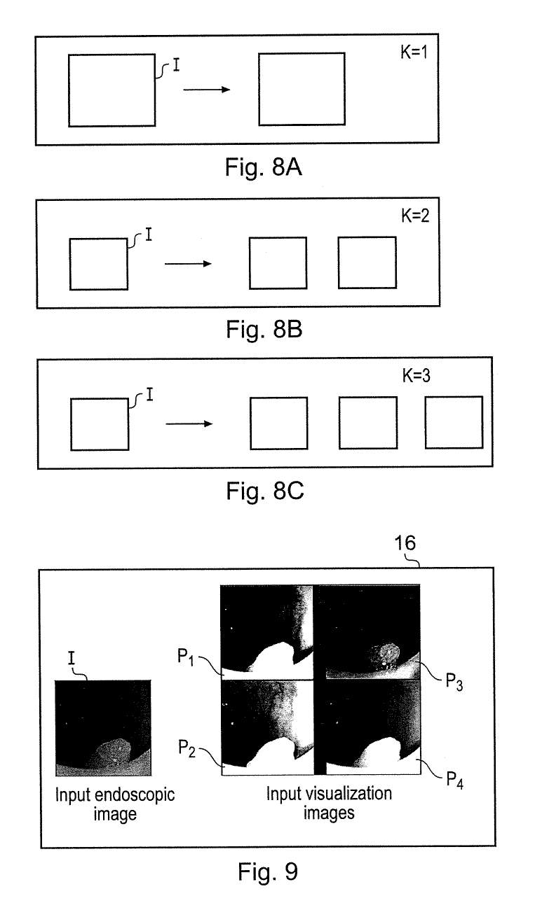

FIG. 8a illustrates a generation of a single processed image for K=1 of the K means clustering algorithm, FIG. 8b is an illustration of two processed images generated for K=2 for the K means clustering algorithm, and FIG. 8c is an illustration of the generation of three processed images using the K means clustering algorithm for K=3;

FIG. 9 is a schematic illustration of four processed images produced on a display screen according to the present technique; and

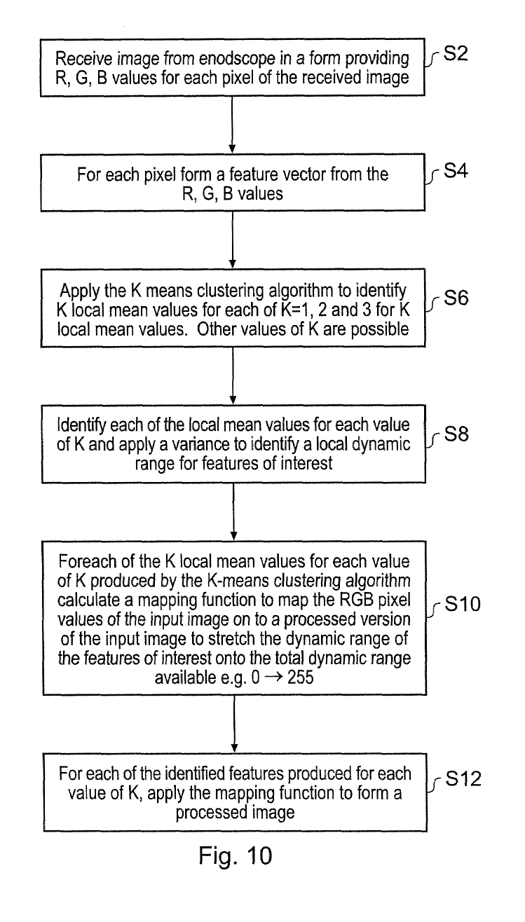

FIG. 10 is an illustrative flow diagram representing the operation of the image processor to produce the processed images from an original input image according to the present technique.

### DESCRIPTION OF THE PREFERRED EMBODIMENTS

FIG. 1 provides an illustrative schematic diagram in which a patient 1 is undergoing invasive surgery using an endoscope 2. The endoscope generates an image which is fed to an image processor 4. The image processor 4 processes the image in order to produce one or more processed versions of that image for display. Thus the processed images are fed to a graphical display unit 6 for display on the display screen 8. As shown in the display screen 6, different versions of an original image 5 are produced, in this example four processed versions P1, P2, P3, P4 are produced. As will be explained, the image I is processed to produce the processed images P1, P2, P3, P4 in order to allow a surgeon to identify more easily abnormalities such as lesions on body parts such as for example, the colon. The endoscopic images sometimes contain saturated shadow areas or bright areas as well as a correctly exposed area which hopefully contains the area of interest, including for example the lesion. The range of pixels which correspond to the lesion can be separated out from the rest of the pixels by using the K-means clustering algorithm. As shadow areas or bright areas are not always present it is not possible to assume that there are three clusters in the distribution of input pixel values. A schematic block diagram of the components embodying the present invention is shown in FIG. 2.

In FIG. 2, a camera 10 generates an image which is fed to an image processor 12 and then to a graphical display unit 14. The graphical display unit 14 then displays on a display screen 16 the original image I and four processed images P1, P2, P3, P4. Embodiments of the present invention process signals representative of the original image I received from the camera 10 in order to generate the processed images P1, P2, P3, P4. Thus, in some examples, the camera 10, graphical display processor 14 and display device 16 may be conventional examples and processing of the image produced by the camera 10 according to the present technique is performed by the image processor 12. The processing performed on the signals representative of the image I by the image processor 12 will now be explained.

As shown in FIG. 3, the image I which may be an image captured by the camera showing a part of the body is received by the image processor 12. The image processor 12 either receives the image in a form in which the pixels have red, green and blue component values (RGB form) or converts the image into RGB form if received in a different form such as luminance and chrominance YUV components. Thus, the pixels of the image I comprise red, green and blue component values R, G, B as illustrated in FIG. 3. As a first operation, the image processor 12 applies a K means clustering algorithm to the pixels of the image in order to identify a number of local mean values associated with area or features of interest which may appear in the image. This parameter of the K means clustering algorithm is referred to as a local mean. Thus, for K=1, only one local mean is identified, for K=2 then two local mean values are identified in the image, and for K=3, three local mean values are identified. The local mean values are identified for image without reference to knowledge of how many actual areas of interest are present in the image. Obviously, if there are three features of interest then K=3 would be the best choice for an assumption that there are three features within the image. Thus, the pixel values are used to form features vectors for application to a K means clustering processor in order to identify k local mean without knowing whether they are the k features of interest. Hence the image processing is automatic.

According to the K means clustering algorithm an initial mean is chosen for each of the K local mean values. A Euclidean distance is then calculated between the initial chosen mean and each of the pixels which are nearest to that “local” mean. The mean value is then adjusted by recalculating the mean in order to minimise the Euclidean distance between the local mean and the pixels which are nearest to the local mean. This process is then repeated until a local mean for pixels nearest to that local mean is determined. Thus, as shown in FIG. 4, if the pixels were plotted in an R, G, B space then they would appear as points in that space. If a local mean μ is selected, the Euclidean distance for each of the pixels for which the local mean is the nearest local mean is calculated. The local mean is then adjusted to minimise that Euclidean distance. The new Euclidean distance is then calculated for the new iteration for the local mean and after several iterations the local mean for a group of pixels is determined.

As a next stage in the processing of the pixel values of the image, the dynamic range of the pixels within a variance range of the mean, referred to as a candidate range, are mapped onto a total dynamic range which is available for presenting the image. This is performed, for example, for several values of K, providing assumptions of the number of features which are of interest in the image. Thus, K for example, is performed for K=1, 2 and 3. For K=1 then one processed image is produced, for K=2 then two processed images are produced and for K=3 then three processed images are produced. This is because for each value K, a local mean is identified and the pixels within a variance value of that local mean have their dynamic ranged mapped on the total dynamic range available for displaying the image. Therefore the candidate ranges are calculated as follows:

1. Calculate the mean (μ) and standard deviation (σ) of the pixels within the image. A range [R_{low}, R_{high}] is calculated from the mean and standard deviation.

R_{low}=μ−σ a.

R_{high}=μ+σ b.
c. The first candidate image is generated by mapping the pixel value (v) in the input image to an output value (v′) as follows:

v′=(v−R_{low})/(R_{high}−R_{low})*255, if R_{low}<v<R_{high} d.
e. 0, if v≦R_{low}
f. 255, if v≧R_{high}
g. If the lesion is the dominant area within the input image, the first candidate image will provide a good visualization of the lesion.

2. Five further ranges are obtained by performing K-means clustering with K=2 and with K=3 and using the means and standard deviations of the resulting clusters.

3. Two of the ranges with the smallest standard deviation are eliminated as these typically correspond to pixels from shadow areas or very bright areas.

4. The corresponding candidate images for the three remaining ranges are generated in the same way as for step 1.

One example is illustrated in FIG. 5. FIG. 5 provides an example for K=2 applied to the K means clustering algorithm for the pixels of an image. FIG. 5 illustrates for example, the pixel values which are red with the image. Since K=2, then there are two local mean values identified which are μ1 and μ2. This assumes that the μ1 and μ2 correspond to two features. Thus feature 1 would have a local mean μ1 and feature 2 would have a local mean μ2. In accordance with the present technique, a dynamic range of candidate values which are to be mapped onto the total available dynamic range are identified by determining points which are plus or minus one variance value from the local mean. Thus, as shown for a first mapping function 20, the values of pixels within the candidate range identified as points 22 and 24 are mapped onto a total dynamic range of 0 to 255 which would be used to represent feature 1. The values outside these ranges would therefore map onto 0 if below the lower point of the candidate range 22 or 255 if above the upper point of the candidate range 24 and would therefore appear as saturated. Correspondingly, for the second local mean μ2, for feature 2, the candidate range of pixel values between points 26 and 28 are mapped onto the total dynamic range as illustrated for the graph 30. The same operation is performed for the other colour components green and blue in order to map the candidate range on to the total dynamic range available. Thus for K=2 two images are produced by mapping the candidate range identified for the two local mean values on to the total dynamic range.

A corresponding example for K=3 is shown in FIG. 6 for the green components. Thus, as shown in FIG. 6, three local mean are identified 40, 42, 44 and the candidate ranges are identified using a variance either side of the local mean, which are shown respectively 46, 48, 50, 52, 54, 56. Since there are three local mean, each of the respective candidate ranges are mapped onto corresponding total dynamic ranges using a mapping function determined for each of the candidate ranges to map the pixels of the input image I to produce three processed images, one for each local mean. As for the previous examples, the mapping of the pixels of the input image onto the available dynamic range to produce the processed image P is illustrated by the dotted lines shown with respect to each of the total available dynamic ranges 60, 62, 64. Correspondingly, the same operation would be performed for the red and blue components.

FIG. 7 illustrates an example for a K=1 case in which a single local mean μ1 is identified, which is used to identify a candidate range to be mapped onto the available dynamic range for the blue component. Again, as for the K=2 and K=3 case the same operation would be performed for the red and green components to map the candidate range onto the total dynamic range available. As illustrated in FIG. 7, as well as FIG. 3, for the input image I being processed there are in fact two features of interest but since the K=1 and K=3 case were processed assuming there were respectively one and three features of interest, then the local mean correspondingly are identified which may not correspond exactly to the peaks in colour values 70, 72 which correspond to actual features which would appear in the image when displayed.

As explained above, for K=1 then one image is generated, for K=2 two images are generated and for K=3 three processed images are generated. Thus in total there are six processed images produced for each of the values K=1, K=2, K=3. This is illustrated in FIG. 8 where for K=1 shown in FIG. 8a, one image is produced, for K=2 shown in FIG. 8b, two images are produced and for K=3, shown in FIG. 8c, three images are produced. However, in order to provide a surgeon with a meaningful representation for images which the surgeon can easily recognise, and taking into account human factors, only four images are displayed and these are shown in FIG. 9 as P1, P2, P3, P4. It is found that with different types of images of lesions, one or more of the candidate images contains an enhanced visualization of the lesion. The detail on the surface of the lesion can be more clearly visible. For the example shown in FIG. 9, the processed image in the top right corner shows a better visualization of the lesion. This makes it easier to diagnose the lesion.

The automatic method of enhancing the contrast in endoscopic images coupled with a small manual step for selecting the appropriate image is a good way to improve the endoscopic examination without having to explicitly detect lesions.

A summary of the operations performed by the image processor 12 is provided by the flow diagram in FIG. 10. The process step as shown in FIG. 10 are summarised as follows:

S1—The image which is to be processed is received from a camera, for example, from an endoscope in a form which provides pixel values having RGB components. Alternatively, the RGB components of the pixels can be calculated by the image processing device.

S4—For each pixel of the image, a feature factor is formed from the RGB values for use in the K means clustering algorithm.

S6—The K means clustering algorithm is then applied to the pixels using the feature vectors to identify K local mean values for each of K=1, K=2 and K=3. Of course, other values of K could be used.

S8—For each of the K local mean values, the mean value is taken and a variance either side of that value is applied to identify a local dynamic range of features of interest.

S10—For each of the K local mean values produced by applying the K means clustering algorithm for each value of K, a mapping function is calculated to map the RGB pixel values of the input image I onto a processed version of the input image to stretch the dynamic range of the candidate range of pixels onto the total dynamic range available such as 0 to 255.

S12—For each of the K local mean values the mapping function is applied to each of the red, green and blue components to produce pixels for each corresponding processed image. The processed images are then displayed.

Various aspects and features of the embodiments described above may be changed and adapted whilst still falling within the scope of the present invention as defined in the appended claims. For example, any value of K could be used to determine the K local mean. Furthermore other ways of determining the local mean other than the K means clustering algorithm could be used. In addition, whilst the embodiment has been described with reference to medical imaging using an endoscope, it would be appreciated that the invention is not limited to medical applications or medical images and could find application in other areas such a topographical processing of images, archaeology and geographical mapping.

### K-Means Clustering Algorithm

K-means (MacQueen. 1967) is one of the simplest unsupervised learning algorithms that solve the well known clustering problem. The procedure follows a simple and easy way to classify a given data set through a certain number of clusters (assume k clusters) fixed a priori. The main idea is to define k centroids, one for each cluster. These centroids should be placed in a cunning way because of different location causes different result. So, the better choice is to place them as much as possible far away from each other. The next step is to take each point belonging to a given data set and associate it to the nearest centroid. When no point is pending, the first step is completed and an early grouping is done. At this point we need to re-calculate k new centroids as barycenters of the clusters resulting from the previous step. After we have these k new centroids, a new binding has to be done between the same data set points and the nearest new centroid. A loop has been generated. As a result of this loop we may notice that the k centroids change their location step by step until no more changes are done. In other words centroids do not move any more. Finally, this algorithm aims at minimizing an objective function, in this case a squared error function. The objective function

$$J = {\sum }_{j = 1}^{k} {\sum }_{i = 1}^{x} {‖ {x}_{i}^{( j )} - {c}_{j} ‖}^{2} ,$$

where ∥xᵢ^{(j)}−cⱼ∥² is a chosen distance measure between a data point xᵢ^{(j)} and the cluster centre cⱼ, is an indicator of the distance of the n data points from their respective cluster centres.
The algorithm is composed of the following steps:

$$1. Place K points into the space represented by the objects that are being clustered . These points represent initial group centroids . \\ 2. Assign each object to the group that has the closest centroid . \\ 3. When all objects have been assigned , recalculate the positions of the K centroids . \\ 4. Repeat Steps 2 and 3 until the centroids no longer move . This produces a separation of the objects into groups from which the metric to be minimized can be calculated .$$

Although it can be proved that the procedure will always terminate, the k-means algorithm does not necessarily find the most optimal configuration, corresponding to the global objective function minimum. The algorithm is also significantly sensitive to the initial randomly selected cluster centres. The k-means algorithm can be run multiple times to reduce this effect.

K-means is a simple algorithm that has been adapted to many problem domains. As we are going to see, it is a good candidate for extension to work with fuzzy feature vectors. More information can be found at:

http://www.elet.polimi.it/upload/matteucc/Clustering/tutorial_html/kmeans.html

Although illustrative embodiments of the invention have been described in detail herein with reference to the accompanying drawings, it is to be understood that the invention is not limited to those precise embodiments, it is to be understood that the invention is not limited to those precise embodiments, and that various changes and modifications can be effected therein by one skilled in the art without departing from the scope and spirit of the invention as defined by the appended claims.

We claim:

1. An image processing apparatus operable to generate at least one processed image from an input image, said image processing apparatus being operable:
to receive said input image represented as a plurality of pixels each of which includes red, green and blue component values,
to identify k local mean for each of said red, green and blue component values of said pixels, where k is an integer,
to identify for each local mean for each of said red, green and blue components, a candidate range of component values, and a mapping function for mapping said candidate range of component values onto a dynamic range of possible component values for representing said image, and
to apply for each of said red, green and blue components of each pixel of said input image said mapping function identified for each of said k local mean, to form for each of said k local mean a processed image for display.

2. An image processing apparatus as claimed in claim 1, wherein said k local mean are identified using a k-means clustering algorithm.

3. An image processing apparatus as claimed in claim 1, wherein said candidate range of component values are identified from a range of values above and below the local mean by an amount equal to the variance of said component values.

4. An image processing apparatus as claimed in claim 2, wherein said candidate range of component values are identified from a range of values above and below the local mean by an amount equal to the variance of said component values.

5. An image processing apparatus as claimed in claim 2, wherein said image processing apparatus is operable to generate a plurality of processed images for display, each image being generated for each local mean identified by said k-means clustering algorithm for a plurality of values of k.

6. An image processing apparatus as claimed in claim 4, wherein said image processing apparatus is operable to generate a plurality of processed images for display, each image being generated for each local mean identified by said k-means clustering algorithm for a plurality of values of k.

7. A system for presenting at least one processed version of an input image produced by a camera, said system comprising
an image processing apparatus, the image processing apparatus being operable:
to receive said input image produced by said camera, said image being represented as a plurality of pixels each of which includes red, green and blue component values,
to identify k local mean for each of said red, green and blue component values, where k is an integer,
to identify for each local mean for each of the pixels for said red, green and blue components, a candidate range of component values, and a mapping function for mapping said candidate range of component values onto a dynamic range of possible component values for representing the image,
to apply for each of said red, green and blue components of each pixel of said input image said identified mapping function, to form for each of the k-local mean a processed image for display, and
a graphical display device operable to receive a signal representative of said processed image produced for each of said k-local mean, and to display the or each processed image on a display screen.

8. A system as claimed in claim 7, wherein said image processing apparatus is operable to identify said k local mean by applying a k-means clustering algorithm.

9. A system as claimed in claim 7, wherein said graphical display device is arranged to receive said signal representative of the image produced by said camera and to display said image produced by said camera with the or each processed image on said display screen.

10. A system as claimed in claim 8, wherein said graphical display device is arranged to receive said signal representative of the image produced by said camera and to display said image produced by said camera with the or each processed image on said display screen.

11. A system as claimed in claim 9, wherein said image processing device is operable to generate a plurality of processed images for either k being greater than one or for a plurality of values of k, and to select a sub-set of the plurality of processed images for display with said image produced by said camera.

12. A system as claimed in claim 10, wherein said image processing device is operable to generate a plurality of processed images for either k being greater than one or for a plurality of values of k, and to select a sub-set of the plurality of processed images for display with said image produced by said camera.

13. A system as claimed in claim 7, wherein said camera is part of an endoscope for use in invasive surgery.

14. An image processing method for generating at least one processed image from an input image, said image processing method comprising:
receiving said input image represented as a plurality of pixels each of which includes red, green and blue component values,
identifying k local mean for each of said red, green and blue component values of the pixels, where k is an integer,
identifying for each local mean for each of the pixels for said red, green and blue components, a candidate range of component values, and a mapping function for mapping said candidate range of component values onto a dynamic range of possible component values for representing said image, and
applying for each of said red, green and blue components of each pixel of said input image said mapping function identified for each of said k local mean, to form for each of said k-local mean a processed image for display.

15. A method as claimed in claim 10, wherein said identifying of said k local means for each of said red, green and blue components includes applying a k-means clustering algorithm.
